(19) United States
(12) Patent Application Publication
(10) Pub. No.: US 2016/0134808 A1
(43) Pub. Date: May 12, 2016

(54) 360-DEGREE PANORAMA DRIVING RECORDER SYSTEM AND METHOD

(71) Applicant: PAPAGO INC., Taipei City (TW)

(72) Inventor: Chih-Chieh FANG, Taipei City (TW)

(21) Appl. No.: 14/665,828

(22) Filed: Mar. 23, 2015

(30) Foreign Application Priority Data
Nov. 7, 2014 (TW) 103138700

(51) Int. Cl. H04N 5/232; H04N 5/225; G03B 37/04

(52) U.S. Cl. CPC H04N 5/23238; G03B 37/04; H04N 5/2254; H04N 5/23293; H04N 5/2253

(57) ABSTRACT

A 360-degree panorama driving recorder system for use in a carrier, including a display unit for displaying image records, three lens and three sensors respectively electrically connected together and mounted inside the carrier for capturing different view angle image records, and a microcontroller unit electrically coupled with the sensors for receiving and integrating the view angle image records captured through the lenses during running of the carrier into an integrated 360-degree panorama image record and then transmitting the integrated panorama image record to the display unit for display.

### CROSS-REFERENCE TO RELATED APPLICATION

This application claims the benefit of Taiwan Patent Application No. 103138700, filed on Nov. 7, 2014, which is hereby incorporated by reference for all purposes as if fully set forth herein.

### BACKGROUND OF THE INVENTION

1. Field of the Invention

The present invention relates to driving recorder technology and more particularly, to a 360-degree panorama driving recorder system, which uses one single main unit to mate with multiple lenses for capturing and recording 360-degree panorama images. The invention relates also to a360-degree panorama driving recording method using the 360-degree panorama driving recorder system.

2. Description of the Related Art

After through technological evolution of driving recorder technology over the years, the function and technical advances of driving recorder have been greatly improved, rendering considerable help in monitoring driving conditions and clarifying the responsibility of traffic accidents. Conventional driving recorders generally provide one single lens or two lenses. When an accident happed, key images may be missed, or not recorded due to a dead angle, increasing the risk of driving safety and leading to an inaccurate accident judgment due to lack of proof.

In order to increase traffic safety and to eliminate imaging dead angle, the demand for a driving recorder having a panorama image recording function has been continuously increasing. A driving recorder having a panorama image recording function needs to use multiple lenses. Regular driving recorders with panorama image recording function are commonly designed for enabling the lenses to be mounted on the outside of the car at different locations in different view angles, for example, at the two rear-view mirrors of the car. This installation method greatly complicates the installation procedure, and also relatively increases the cost of the system.

Further, mounting the lenses of a driving recorder on the outside of the body of a car should consider various risks in the external environment, such as rain, impact and abrasion, etc. Therefore, it is desirable to provide a driving recorder system for recording 360-degree panorama images that allows the lenses to be installed on the inside of a car.

### SUMMARY OF THE INVENTION

The present invention has been accomplished under the circumstances in view. It is the main object of the present invention to provide a 360-degree panorama driving recorder system, which uses one single main unit to mate with multiple lenses for capturing and recording 360-degree panorama images.

To achieve this and other objects of the present invention, a 360-degree panorama driving recorder of the invention is installed in a carrier, comprising a display unit for displaying image records, at least one lens and at least one sensor respectively electrically connected together for capturing different view angle image records, and a microcontroller unit electrically coupled with the sensors for receiving the view angle image records captured through the lenses during running of the carrier and integrating the view angle image records into an integrated 360-degree panorama image record and then transmitting the integrated 360-degree panorama image record to the display unit for display.

To achieve this and other objects of the present invention, a 360-degree panorama driving recording method of the invention comprise the step of providing a display unit in a carrier, the step of installing lenses sensors in the carrier for capturing at least one view angle image record, and the step of installing a microcontroller unit in the carrier and electrically coupling the microcontroller unit with the lenses and the sensors for receiving multiple view angle image records from the lenses through the sensors and integrating the view angle image records into an integrated 360-degree panorama image record and then transmitting the integrated 360-degree panorama image record to the display unit for display.

The 360-degree panorama driving recorder system of the invention utilizes a software program to integrate multiple view angle image records captured by multiple lenses through multiple sensors into a 360-degree panorama image record for display and storage. As the invention uses one single main unit to mate with multiple lenses for capturing and recording 360-degree panorama images, the invention greatly reduces the system installation cost. Further, the invention has the lenses and sensors installed inside the carrier, saving much the maintenance cost and prolonging the system lifespan. Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a block diagram of a 360-degree panorama driving recorder system in accordance with the present invention.

FIG. 2 is a schematic drawing illustrating different view angle image records captured by the 360-degree panorama driving recorder system in a carrier in accordance with the present invention.

FIG. 3 is a schematic drawing illustrating an integrated 360-degree panorama image record displayed on the display unit.

FIG. 4 is a block diagram illustrating transmission of different view angle image records through the image integration module to the display unit in accordance with the present invention.

### DETAILED DESCRIPTION OF THE INVENTION

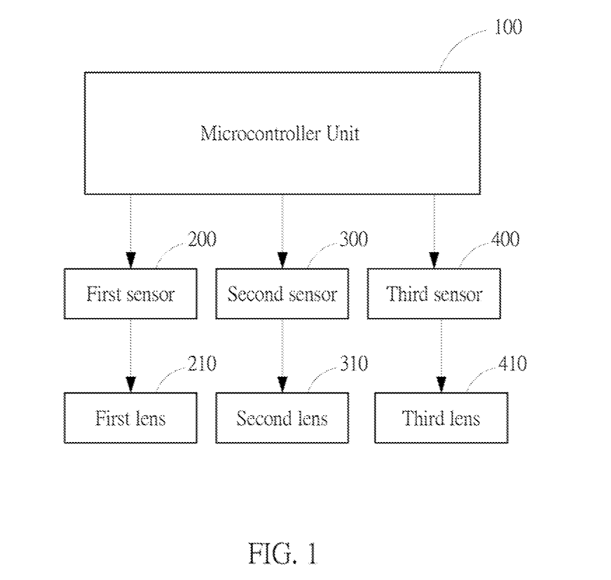

Referring to FIG. 1, a block diagram of the hardware composition of a 360-degree panorama driving recorder system is shown. As illustrated, the 360-degree panorama driving recorder system comprises at least three lenses. Each lens is electrically connected to a respective sensor and a microcontroller unit.

The 360-degree panorama driving recorder system is mountable in a carrier, for example, a car, or any other transportable vehicle. The 360-degree panorama driving recorder system further comprises a display unit having a display screen for displaying recorded images. In this embodiment, the 360-degree panorama driving recorder system comprises at least three lenses. Each lens is electrically connected to a respective sensor and a microcontroller unit. In the embodiment shown in FIG. 1, the 360-degree panorama driving recorder system comprises three lenses, namely, the first lens 210, the second lens 310 and the third lens 410, a first sensor 200 electrically coupled with the first lens 210 for capturing a first view angle image record 220, a second sensor 300 electrically coupled with the second lens 310 for capturing a second view angle image record 320, and a third sensor 400 electrically coupled with the third lens 410 for capturing a third view angle image record 420.

The first lens 210, the second lens 310 and the third lens 410 are arranged on one level. The hardware design of the 360-degree panorama driving recorder can have a spherical or rectangular configuration. The positions of the lenses can be changed according to the design of the driving recorder. In another embodiment of the present invention, the first lens 210, the second lens 310 and the third lens 410 are respectively equipped with a respective view angle adjuster for adjusting the direction of the first view angle image record 220, the direction of the second view angle image record 320 and the direction of the third view angle image record 420 respectively at different elevations. When increasing the number of the lenses, the number of the view angle adjuster and the number of the view angle image records shall be relatively increased.

The image record displayed on the display unit is a combination of the first view angle image record 220, the second view angle image record 320 and the third view angle image record 420 synthesized by the microcontroller unit 100. The display unit further comprises a touch unit for inputting a control instruction to adjust the display mode of the display unit.

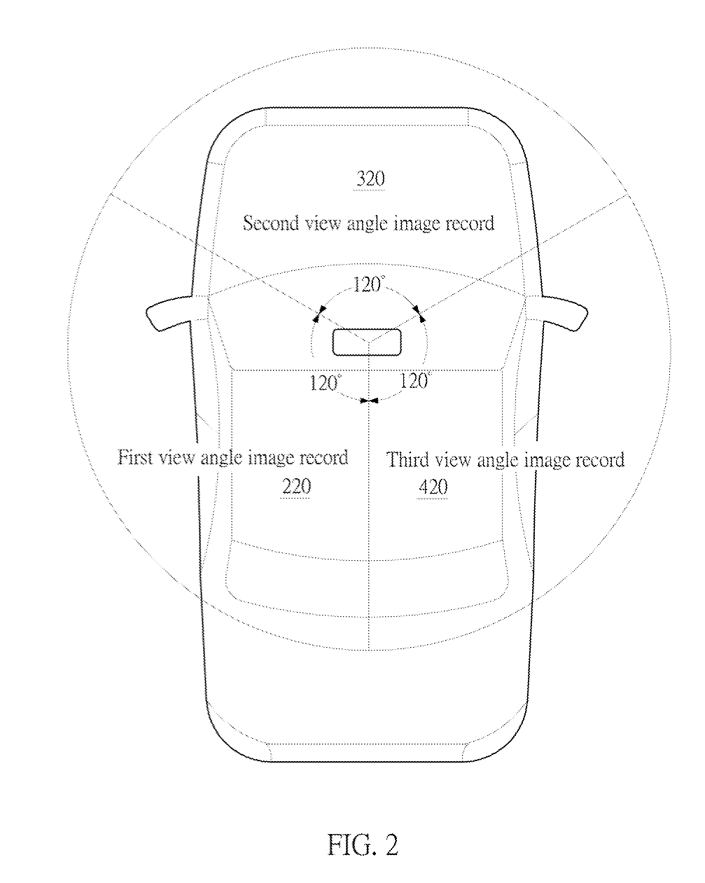

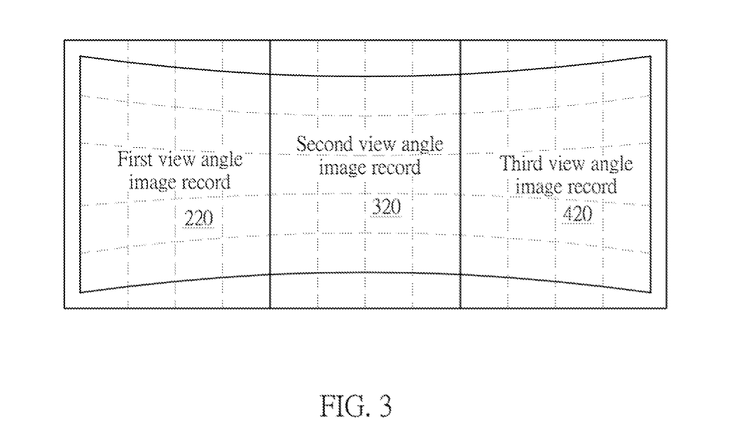

Referring to FIGS. 2 and 3, the image record displayed on the display unit can be a single view angle image record, or a combination of multiple view angle image records, and the display mode of the display unit is adjustable by means of a control instruction. In FIG. 3, a panorama view of the combination of the first view angle image record 220, the second view angle image record 320 and the third view angle image record 420 is shown. Referring also to FIG. 2, the image capturing range of the first lens 210, the image capturing range of the second lens 310 and the image capturing range of the third lens 410 are shown.

The 360-degree panorama driving recorder system of the invention further comprises a network device linkable to the Internet. The view angle image records of the lenses can be transmitted to the display screen of the display unit by a wired or wireless transmission interface. Through the Internet, these view angle image records can be transmitted to a mobile electronic device.

The 360-degree panorama driving recorder system of the invention further comprises a storage module electrically connected to the microcontroller unit 100 for storing the view angle image records, and interface means (for example, USB interface) for the connection of an external storage device for storing view angle image records. Through this interface means, view angle image records can be stored in or fetched from the connected external storage device.

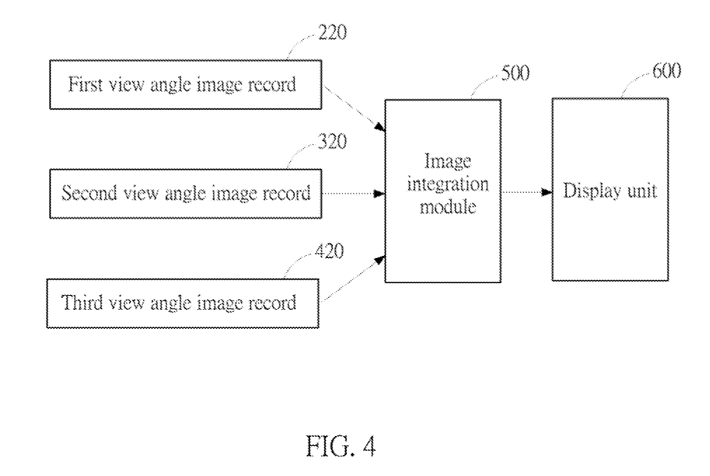

During running of the carrier, the microcontroller unit 100 of the 360-degree panorama driving recorder system obtains and processes the view angle image records of continuous series of images of the lenses through the respective sensors, and then transmits these view angle image records to the display unit 600 for display. Referring also to FIG. 4, the microcontroller unit 100 comprises an image integration module 500 adapted for integrating the first view angle image record 220, the second view angle image record 320 and the third view angle image record 420 through an algorithm, and the integrated view angle image record is then transmitted to the display unit 600 for display.

The image integration module 500 of the microcontroller unit 100 computes the error value of the image overlap of the view angle image records. There is an image overlap between multiple image records captured by different lenses. By means of a software program, the microcontroller unit 100 applies an arithmetic processing to integrate multiple view angle image records with the error value minimized, and then transmits the integrated view angle image record to the display unit 600 for display.

In conclusion, the invention provides a 360-degree panorama driving recorder system, which utilizes a software program to integrate multiple view angle image records captured by multiple lenses through multiple sensors into a 360-degree panorama image record for display and storage. As the invention uses one single main unit to mate with multiple lenses for capturing and recording 360-degree panorama images, the invention greatly reduces the system installation cost. Further, the invention has the lenses and sensors installed inside the carrier, saving much the maintenance cost and prolonging the system lifespan.

Although a particular embodiment of the present invention has been described in detail for purposes of illustration, various modifications and enhancements may be made without departing from the spirit and scope of the invention. Accordingly, the invention is not to be limited except as by the appended claims.

What is claimed is:

1. A 360-degree panorama driving recorder system installed in a carrier for capturing and recording 360-degree panorama images, comprising:
a display unit for displaying image records;
at least three lenses and at least three sensors respectively electrically to said at least three lenses and mounted with said at least three lenses inside said carrier for capturing at least one view angle image record; and
a microcontroller unit electrically coupled with said at least three sensors for receiving and processing said least one view angle image record during running of said carrier, and then transmitting the processed said at least one view angle image record to said display unit for display.

2. The 360-degree panorama driving recorder system as claimed in claim 1, wherein the number of said at least three lenses is 3, and these three lenses are respectively named as the first lens, the second lens and the third lens.

3. The 360-degree panorama driving recorder system as claimed in claim 1, wherein said first lens, said second lens and said third lens are arranged on one same level.

4. The 360-degree panorama driving recorder system as claimed in claim 2, wherein said first lens, said second lens and said third lens are respectively equipped with a respective view angle adjuster for adjusting the direction of image record in a first view angle, the direction of image record in a second view angle and the direction of image record in a third view angle respectively at different elevations.

5. The 360-degree panorama driving recorder system as claimed in claim 2, wherein said first lens is adapted for capturing a first view angle image record; said second lens is adapted for capturing a second view angle image record; said third lens is adapted for capturing a third view angle image record.

6. The 360-degree panorama driving recorder system as claimed in claim 2, wherein said microcontroller unit integrates a first view angle image record captured by said first lens, a second view angle image record captured by said second lens and a third view angle image record captured by said third lens into an integrated 360-degree panorama image record for display on said display unit.

7. The 360-degree panorama driving recorder system as claimed in claim 1, wherein said display unit comprises a touch unit for inputting a control instruction.

8. The 360-degree panorama driving recorder system as claimed in claim 1, further comprising a network device for transmitting view angle image records captured by said at least three lenses to a display screen of said display unit selectively by a wired or wireless transmission interface.

9. The 360-degree panorama driving recorder system as claimed in claim 1, further comprising a display unit controller for switching a display screen of said display unit to selectively display one single said view angle image record or the integration of multiple said view angle image records.

10. The 360-degree panorama driving recorder system as claimed in claim 1, further comprising a storage module electrically connected to said microcontroller unit for storing said at least one view angle image record.

11. The 360-degree panorama driving recorder system as claimed in claim 9, wherein said storage module comprises interface means for the connection of an external storage device for storing said at least one view angle image record.

12. The 360-degree panorama driving recorder system as claimed in claim 1 wherein said microcontroller unit comprises an image integration module adapted for computing the error value of an image overlap of multiple said view angle image records, and integrating multiple said view angle image records into an integrated view angle image record for display on said display unit.

13. A 360-degree panorama driving recording method for use in a carrier, comprising the steps of:
a) providing a display unit in said carrier for display image records;
b) installing at least one lens and at least one sensor inside said carrier for capturing at least one view angle image record; and
c) installing a microcontroller unit in said carrier and electrically coupling said microcontroller unit with said at least one lens and said at least one sensor for receiving at least one view angle image record from said at least one lens through said at least one sensor and integrating said at least one view angle image record into an integrated view angle image record and then transmitting said integrated view angle image record to said display unit for display.

14. The 360-degree panorama driving recording method as claimed in claim 13, wherein the number of said at least three lenses is 3, and these three lenses are respectively named as the first lens, the second lens and the third lens.

15. The 360-degree panorama driving recording method as claimed in claim 13, wherein said first lens, said second lens and said third lens are arranged on one same level.

16. The 360-degree panorama driving recording method as claimed in claim 14, wherein said first lens, said second lens and said third lens are respectively equipped with a respective view angle adjuster for adjusting the direction of image record in a first view angle, the direction of image record in a second view angle and the direction of image record in a third view angle respectively at different elevations.

17. The 360-degree panorama driving recording method as claimed in claim 14, wherein said first lens is adapted for capturing a first view angle image record; said second lens is adapted for capturing a second view angle image record; said third lens is adapted for capturing a third view angle image record.

18. The 360-degree panorama driving recording method as claimed in claim 14, wherein said microcontroller unit integrates a first view angle image record captured by said first lens, a second view angle image record captured by said second lens and a third view angle image record captured by said third lens into an integrated 360-degree panorama image record for display on said display unit.

19. The 360-degree panorama driving recording method as claimed in claim 13, wherein said display unit comprises a touch unit for inputting a control instruction.

20. The 360-degree panorama driving recording method as claimed in claim 13, further comprising a network device for transmitting view angle image records captured by said at least three lenses to a display screen of said display unit selectively by a wired or wireless transmission interface.

21. The 360-degree panorama driving recording method as claimed in claim 13, further comprising a display unit controller for switching a display screen of said display unit to selectively display one single said view angle image record or the integration of multiple said view angle image records.

22. The 360-degree panorama driving recording method as claimed in claim 13, further comprising a storage module electrically connected to said microcontroller unit for storing said at least one view angle image record.

23. The 360-degree panorama driving recording method as claimed in claim 22, wherein said storage module comprises interface means for the connection of an external storage device for storing said at least one view angle image record.

24. The 360-degree panorama driving recorder system as claimed in claim 13, wherein said microcontroller unit comprises an image integration module adapted for computing the error value of an image overlap of multiple said view angle image records, and integrating multiple said view angle image records into an integrated view angle image record for display on said display unit.
